(19) United States
(12) Patent Application Publication
(10) Pub. No.: US 2020/0258009 A1
(43) Pub. Date: Aug. 13, 2020

(54) METHOD FOR MAKING AVAILABLE A VEHICLE AND ITS RETURN IN A FLEET OF VEHICLES AVAILABLE FOR RESERVATION, RESERVATION METHOD OF A VEHICLE, SYSTEM

(71) Applicant: VULOG, Nice (FR)

(72) Inventor: François COLON, Marseille (FR)

(73) Assignee: VULOG, Nice (FR)

(21) Appl. No.: 16/760,477

(22) PCT Filed: Oct. 30, 2018
(86) PCT No.: PCT/FR2018/052685

§ 371 Date: Apr. 30, 2020

(51) Int. Cl. G06Q 10/02; G06F 16/245; G06F 16/29; G06Q 50/30; G06Q 10/04; G06Q 10/08; G06Q 10/10; G01C 21/34

(52) U.S. Cl. CPC G06Q 10/02; G06F 16/245; G06F 16/29; G01C 21/3438; G06Q 10/047; G06Q 10/0833; G06Q 10/1095; G06Q 50/30

(57) ABSTRACT

A method for making available a vehicle, including generating a first query from a first device of a first user of a vehicle, to a server from a data network, in order to indicate a making available of said vehicle in a first zone; receiving of a third query by the first device, from the remote server, indicating a request for access to said vehicle by a second user; acceptance of the request for access from the first device, and in the first query includes a piece of information on vehicle availability, a piece of status information indicating a status of the vehicle specifying that the vehicle is in operation, and; a first piece of geographical information.

### FIELD

The field of the invention concerns methods for reserving a vehicle. The field of the invention also concerns methods for making available a vehicle and return it in a fleet of vehicles available for reservation. The field of the invention more specifically concerns the methods implemented from a smartphone or a portable electronic device.

### STATE OF THE ART

There are methods for reserving and making available a vehicle, in particular, a motor vehicle. In these methods, generally a personal vehicle or a professional fleet is made available within a fleet of vehicles.

Document US 2015 0348178 A1 describes a method for subleasing a vehicle for a predefined duration, for example from a smartphone. A request is made from a device of a first user who access, thanks to a server, a list of vehicles available responding to the request made (duration, localization, price, etc.). The server transmits a query corresponding to a choice of the lessee to an owner.

A disadvantage, for the owner, of such a method is to have to park their vehicle in a certain localization. Finally, there is no solution making it possible for an owner of a vehicle to make available their vehicle, whenever and whatever the location of the vehicle.

Document US 2015 206206 describes a method and system for exchanging vehicles between drivers. A server can record leasing desire queries of a first user and alert another recorded user that the first user wants to exchange or lease their vehicle. The system proposes to assist the exchange by the definition of a place and a time of exchange. The exchange query can comprise price or duration data.

A disadvantage of this system is that each user must fix a meeting point and move their vehicle to exchange it. The system described does not propose any service for people not having any vehicle or wanting to simply reserve a vehicle according to where it is located.

The invention aims to overcome the abovementioned disadvantages.

### SUMMARY OF THE INVENTION

The solution proposed by the invention is a method for making available a vehicle comprising the following steps:
generating a first query from a first device of a first user to a server from a data network in order to indicate a making available of said vehicle in a first zone;
receiving a third query by the first device from the remote server indicating a request for access to said vehicle by a second user wanting to reserve said vehicle;
acceptance of the request for access from the first device.

This method is notable in that the first query comprises:
a piece of information on vehicle availability,
a piece of status information of the vehicle specifying that the vehicle is in operation, and;
a first piece of geographical information.

The user can make available their vehicle, whenever and whatever the location of the vehicle, without having to fix a meeting point or move their vehicle to exchange it.

This method can be implemented in a solution that already exists of a system for making available vehicles from among a set of vehicles of a fleet, for example, of individuals or of a fleet of vehicles dedicated for leasing.

One of the other advantages of the invention is to be able to increase a fleet of vehicles available to a community of people by considering vehicles in an operating status for which the driver seeks to park in a space.

Another advantage of the invention is to decrease traffic in cities by decreasing, in particular, the moving of certain vehicles which seek to be parked. Thus, the consumption of these vehicles lowers, as it becomes useless to move for a certain time before finding a space. Finally, the method of the invention makes it possible to transmit a vehicle ready for use, the engine humming and the radio switched on.

The method of the invention furthermore has as an advantage, to be able to report at least one vehicle including a piece of information relating to the status of a vehicle of the list, for example, “in use”.

Other advantageous features of the invention are listed below. Each of these features can be considered individually or in combination with the notable features defined above, and form the subject, if necessary, of one or more divisional patent applications:

Advantageously, the server sends a geographical position corresponding to a meeting point with the second user, which geographical position: is calculated from a first position corresponding to the current position of the vehicle; and/or is calculated from a second position corresponding to the current position of the second user; and/or is determined from a common zone of the first zone defined around the first position and a second zone defined around the second position.

Advantageously, the geographical position corresponding to the meeting point is calculated between the first position and the second position, by considering at least one of the following factors: the direction of moving of the vehicle; the nature of the path wherein the vehicle is engaged, such as a one-way street or a two-way street; a better route in terms of distance, of time of arrival or of traffic to arrive until a position of a path leading to the second position.

Advantageously, the first geographical piece of information includes: a first position corresponding to the current position of the vehicle; and/or a first zone defined around the first position.

The third query advantageously includes a second piece of geographical information, said second piece of geographical information including: a second position corresponding to the current position of a user; and/or a second zone defined around the second position.

According to an embodiment variant, the third query includes: a second geographical position corresponding to a position of a second user wanting to reserve the vehicle; and/or a third geographical position corresponding to a position of a meeting point calculated from the first position and/or a second position corresponding to a position of a second user wanting to reserve the vehicle.

This third geographical position can be determined from a common zone of the first zone and of the second zone.

This third query can include a piece of distance or time information further including an estimated duration calculated from a current position of the vehicle and the third geographical position.

Preferably, the piece of status information further includes a piece of data corresponding to: a description of a space occupied by the vehicle from among which: {double parking; red light; boat; delivery; move} ; and/or a parking description of the vehicle from among which: {indicating; warning; traffic lights}; and/or a description of the vehicle from among which: {color, model, make, year}.

The method can further include the step of: recording in a memory of the server (of availability information of the new vehicle and of the first piece of geographical information following the receiving, to the first query).

The method can further include the steps of: receiving a second query by the server coming from a second device of a user, said second query including a request for reserving a vehicle available in a second zone; generating a list of vehicles including data relating to their availability to the device of the pedestrian, said list including the first vehicle; sending said list of vehicles to the second device; selecting the first vehicle from the second device; sending the third query to the first device.

The acceptance of the request for access from the first device advantageously comprises: the generating of a message by the first device to the server validating the making available of the vehicle; the generating of a message by the server to the second device mentioning a meeting position.

Another aspect of the invention concerns a computer program product including a calculator and a memory for the implementation of any one of the steps of the method described above.

Also, another aspect of the invention concerns a system including at least one mobile terminal and a server for the implementation of any one of the steps of the method described above.

Also, another aspect of the invention concerns a method for reserving a vehicle ready for use comprising the following steps:
generating a query from a device of a user wanting to reserve a vehicle ready for use, said query being sent to a server from a data network, in order to indicate a request for access to a vehicle in a zone defined around a given geographical position;
receiving a message including a list coming from the server, said list including a set of data relating to available vehicles and of which at least one vehicle is associated with a piece of status data of the vehicle specifying that the vehicle is in operation;
selecting said vehicle and sending a reservation command from the vehicle to the server;
receiving a message by the device of the user coming from the server indicating a position of said vehicle and a descriptive element of the vehicle;
an acceptance of the reservation by means of the device of the user.

This reservation method can further comprise a step of sending, from the server, of a geographical position corresponding to a meeting point of the user, which geographical position:
is calculated from a first position corresponding to the current position of the vehicle; and/or
is calculated from a second position corresponding to the current position of the user; and/or
is determined from a common zone of the first zone defined around the first position and of a second zone defined around the second position.

Also, another aspect of the invention concerns a computer program product including a calculator and a memory for the implementation of the method for reserving a vehicle.

Also, another aspect of the invention concerns a system including at least one mobile terminal and a server for the implementation of the method for reserving a vehicle.

### BRIEF DESCRIPTION OF THE FIGURES

Other features and advantages of the invention will emerge upon reading the following detailed description, in reference to the appended figures, which illustrate:

FIG. 1: an embodiment example of the steps of a method for making available and a method for reserving a vehicle;

FIG. 2: a representation example from a mapping of the position information of the first and of the second user;

FIG. 3: an embodiment example of a data network making it possible to establish communications between a remote server and a first mobile device and a second mobile device.

### DESCRIPTION

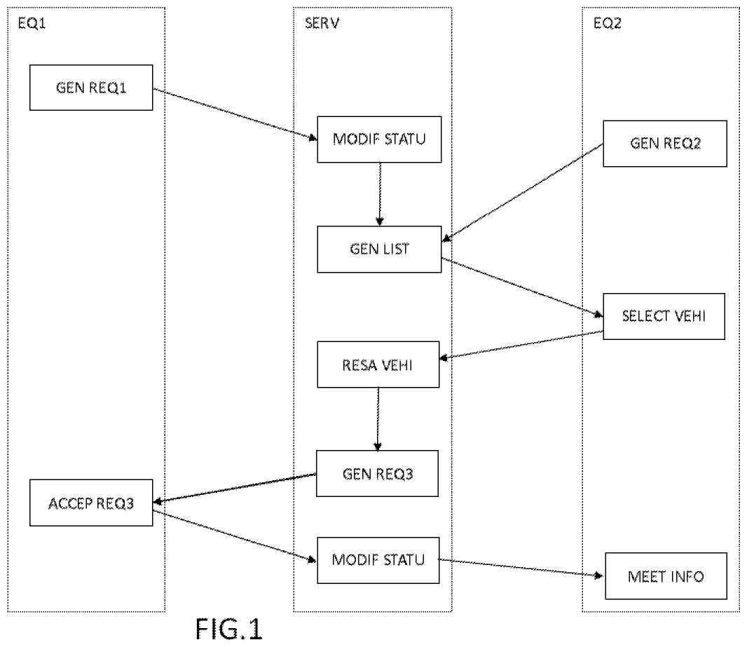

FIG. 1 represents three entities of which a first device EQ₁, EQ₂ of a user U₁, a second device EQ₂ of a second user U₂ and a remote server referenced SERV.

### Devices, Server

According to a first embodiment, the devices EQ₁, EQ₂ are mobile electronic devices including a communication interface, for example GSM, 3G, 4G or Wi-fi, to establish a wireless communication connection with a communication device of a data network, such as the internet network. The communication device can be, for example, a switch, a router, a server of a network, a base station of a mobile terminal network, like for example, an eNodeB or a NodeB for the LTE, UMTS networks.

The devices EQ₁, EQ₂ are preferably smartphones or digital tablets. According to an embodiment, the devices comprise, for example, a code which can be executed by a downloadable application making it possible to carry out functions of the methods of the invention.

The server SERV carries out certain steps of the methods of the invention which could also correspond to functions of a piece of software. It can be one single device such as a computer including resources making it possible to carry out the functions of a server. According to an alternative of the invention, the functional server SERV can be ensured by a plurality of servers, i.e. of computers. As an example, an authentication server, making it possible in particular, to manage user rights and a server storing the information of the fleet of vehicles can be configured to carry out the methods of the invention.

According to another example, the data of the users and the data of the vehicles are stored in a cloud, including a plurality of memory resources synchronized together and accessible from the data network.

### Generating a Query for Making Available

According to an embodiment example, the method includes a step of generating a first query REQ₁ by a first user U₁ of a vehicle AUTO₁. This step is referenced GEN_REQ₁ in FIG. 1. This user U₁ can be, for example, the driver of the vehicle AUTO₁ or a passenger of the vehicle. The first user U₁ is, for example, in a location where they seek to park the vehicle in a parking space. According to an embodiment, the parking spaces of the fleet of vehicles are public or private parking spaces available, for example, in the city. In another embodiment, the parking spaces are spaces defined in specific places such as a set of spaces of a carpark and which are predefined in advance.

When the first user U₁ does not find any spaces, the method of the invention makes it possible for the latter to make their vehicle available within a community of users possibly wanting to reserve a vehicle in a zone which is close, even in the proximity of the first user. The first query REQ₁ therefore includes a piece of information relating to the immediate making available of the vehicle, referenced, for example, “DISPO” or in a period to come, for example if the user U₁ wants to program their making available in a duration corresponding to their time of arrival in a given zone, for example “10 min DISPO” to indicate that the vehicle will be made available in the fleet of vehicles in 10 min.

Furthermore, the first query REQ₁ includes a piece of data relating to the operating status of the vehicle. As an example, an active status corresponds to the fact that the vehicle is in operation, for example, “SOS PLACE” to indicate that the vehicle is in operation and that a space is sought. According to an embodiment, the status “SOS PLACE” can also indicate that the vehicle is available immediately.

An advantage is that the method of the invention can be implemented in a solution that already exists of a system for making available vehicles from among a set of vehicles of a fleet, for example of individuals or of a fleet of vehicles dedicated for leasing. The current system should thus be modified to include the steps of the method making it possible to make available a vehicle in use.

According to an embodiment, the query REQ₁ includes a piece of geographical information including, for example, a position of the vehicle POS₁, such as a position obtained by satellite or a position obtained by a triangulation system or by a combination of the two localization systems. In this case, the position used by the method of the invention is the current position POS_{C} of the vehicle, then POS₁=POS_{C}. The system of positioning by satellite can be, for example, the GPS or Galileo system. The triangulation system can, for example, use the cells of a 4G network or router devices of a Wi-fi network.

According to an alternative, the position can correspond to a position POS defined from an input interface of the first device EQ₁. For example, if the first user U₁ evaluates a position from an interactive map or by evaluating a future position corresponding to their arrival at a given date in a given time. In the latter case, they can make available their vehicle AUTO₁ in a given time window corresponding approximately to their estimated travel time.

According to another embodiment which can be combined with the latter embodiment, the geographical information is a region or a zone Z₁ wherein the vehicle AUTO₁ is found at the moment of the sending of the query REQ₁ or will be found in a predefined duration. The zone Z₁ can be directly or indirectly defined from a position POS₁, for example, a zone defining a circle around the position POS₁ of a predefined radius or diameter or a zone Z₁ corresponding to a district wherein the position the position POS₁ is located. The districts can, for example, be defined in a database and correspond to regions defined by postcodes or by regions delimited by streets and defining known districts.

The query REQ₁ therefore includes at least the three following pieces of information:
a piece of information relating to the availability of the vehicle to be accessible to a community of people wanting to reserve a vehicle in a given zone;
a piece of geographical information including at least one position POS₁ or a geographical zone Z₁;
a piece of status data of the vehicle specifying that the latter is in use. Such an indicator can be, for example, of the type “SOS PLACE” indicating that the user making available their vehicle is seeking a parking space.

One of the advantages of the invention is to increase a fleet of vehicles available to a community of people by considering vehicles in operating status for which the driver seeks to park in a space. Another advantage of the invention is to decrease traffic in cities by decreasing, in particular, the moving of certain vehicles which seek be parked. Thus, the consumption of these vehicles lowers, as it becomes useless to move for a certain time before finding a space. Finally, the method of the invention makes it possible to transmit a vehicle ready for use, the engine humming and the radio switched on.

When such a query REQ₁ is sent to a remote server SERV, the latter automatically updates a database of vehicles available. The server SERV comprises an interface and a calculator making it possible to decode a message sent by a device of a user U₁. The server SERV can be coupled to another authentication server, for example, making it possible to recognize the user U₁ and to associate it with the predefined rights. For example, an authentication server can, for example, manage user rights relating to a set of users of a leasing service of a fleet of vehicles and of associated services, like for example collected points relating to good practice, a frequency of use, of a price paid, etc.

According to an embodiment, when the query REQ₁ is sent, a piece of awaiting information is generated on the interface of the device EQ₁ in order to report to the user U₁ that the request is being processed. This awaiting information can be automatically generated by the device EQ₁ or by the server SERV.

The server SERV updates a database of vehicles available of a given fleet by adding the vehicle AUTO₁ as being an available vehicle. This step is referenced MODIF_STATU in FIG. 1. Furthermore, the server SERV updates the status of the vehicle as being a vehicle in use. Finally, the database is updated with a locality such as the current position POS1 or the predefined position by the user U₁ corresponding to a position to reach or also a defined zone with respect to either of these positions.

The server SERV comprises a calculator capable of generating lists of vehicles available according to certain input criteria or a combination of the latter, such as, for example:
a position or a given zone,
a sought motorization of the vehicle,
a leasing price to not be exceeded,
a type of vehicle from among a list of the type {urban, street, utility, truck, etc.}
a space number available in the vehicle,
a type of fuel,
an immediate or subsequent availability,
a vehicle in use or a parked vehicle.

According to an embodiment, the method of the invention generates an ordered list by considering a priority indicator. This step is referenced GEN_LIST in FIG. 1. A priority indicator can be raised in the vehicle is in use, for example, when the user U₁ seeks a space, the status data of the vehicle being “SOS_PLACE”. However, the priority indicator can be lower if the vehicle is parked, and in a zone far from a position at which a vehicle will be reserved.

FIG. 1 represents a second device EQ₂ of a user U₂ wanting to reserve a vehicle in a zone Z₂. A query REQ₂ including a request for accessing a vehicle is generated from a data connection of a mobile network, for example. This step is referenced GEN_REQ₂ in FIG. 1. A wireless communication interface is preferably used if the device EQ₂ is, for example, a smartphone.

The query REQ₂ includes, for example, a known user ID of the authentication server and a position of the user U₂ or a zone Z₂ like, for example, a district wherein they want to reserve a vehicle. The query REQ₂ is received by the remote server SERV or a server synchronized with the server SERV sharing the hosted data. The server receiving the query REQ₂ is a server connected to the data network.

In the embodiment of FIG. 1, the user U₂ seeks a vehicle in a zone Z₂ in the proximity of the position POST of the user U₁. According to an embodiment, the position of the second user POS₂ can be completed in the formulation of the search for a vehicle by the user U₂ by the definition of a radius around the position POS2 The region thus defined around the position POS₂ defines a second search zone Z₂.

According to an embodiment, the search zone Z₂ is compared with other zones associated with available vehicles, such as the zone Z₁. The method makes it possible to define a common region of a sought zone such as the zone Z₁ and the zone wherein the second user U₂ is located.

The server SERV or a server of the network having a connection with the server SERV includes a calculator to generate a list of available vehicles in the proximity of the position POS₂ of the user U₂. The list of vehicles is thus sent to the device EQ₂. According to an embodiment, it can be ordered with priority levels. The user U₂ is thus able to select a vehicle from among the list which has been generated and sent to their device EQ₂ in order to reserve it and to access it. This step is referenced SELEC_VEHI in FIG. 1.

The method of the invention has the advantage of reporting at least one vehicle including a piece of information relating to the status of a vehicle of the list, for example: “in use”, otherwise called “SOS PLACE”. According to an embodiment, the list includes a first group of vehicles having a status “in use”. Thus, the user U₂ can try to lease as a priority, a vehicle ready for operation without risk of incident upon starting it, as the vehicle has been used recently. It is also a way to save time upon the taking charge of the vehicle and also to sensitize a population to the decrease of exhaust gas emissions in cities.

In order to finalize the reservation of a vehicle such as the vehicle AUTO₁ made available by the user U₁ in a zone close to the position of the user U₂, a confirmation sequence succeeds the sending of the first query REQ₁ and the second query REQ₂ of each of the users and of the selection of the vehicle AUTO1 by the user U₂.

In this confirmation sequence, the server SERV records in a memory, the vehicle selected AUTO₁ by the user U₂ from the device EQ₂. According to an embodiment, the vehicle AUTO₁ is thus reserved and therefore unavailable for other users Uᵢ. This step is referenced RES_VEHI in FIG. 1. The server SERV therefore generates lists for other users wanting to reserve a vehicle in one same zone or a neighboring zone without the vehicle AUTO₁ appearing in these lists thus generated.

The server SERV automatically generates a query REQ3 to the device EQ₁ of the first user U₁ in order to inform it that a user U₂ has reserved the vehicle AUTO₁. This step is referenced GEN_REQ3 in FIG. 1. A meeting position POS₃ is thus sent by the server SERV in order to indicate a meeting point to the first user U₁. According to an embodiment, the meeting position POS₃ is sent in a message following the sending of the query REQ₃ informing the interest for the vehicle AUTO₁ from the second user U₂ to the first user U₁.

According to an embodiment, the meeting position POS₃ is the first position POS₁. According to another embodiment, the meeting position POS₃ is the position POS₂. According to another embodiment, this is a position calculated between the position POS₁ and the position POS₂. In the latter case, the position POS₃ can consider at least one of the following factors:
the position of the vehicle POS₁,
the moving direction of the vehicle AUTO₁,
the nature of the path wherein the vehicle AUTO₁ is engaged, such as a one-way street or a two-way street,
a better route in terms of distance, of time of arrival or of traffic to arrive until a position of a path leading to the second position POS₂.

According to a first embodiment, the meeting position POS₃ is, by default, the position POS₁ sent during the first query REQ₁.

According to an embodiment, when the user U₁ receives the query REQ₃ on their device EQ₁, it can confirm the position POS₃ proposed by the server SERV when such a position is proposed during the sending of the query REQ₃. This step is referenced ACCEP_REQ₃ in FIG. 1.

According to an embodiment, the user U₁ can modify the position POS₃ proposed by the server and choosing from it another if the latter does not suit it. According to another embodiment, the user U₁ directly chooses a position POS₃, for example if it is not provided that the server SERV generates one of them. To this end, different embodiments can be considered according to which device of EQ₁, EQ₂ or SERV defines the position POS₃ or proposes it to other devices. A priority to the device EQ₁/the user U₁ can be given when the traffic is dense or a priority to the device EQ₂/the user U₂ can be given when the distance between the vehicle and the user U₂ is greater than a predefined threshold. According to an example, the information of the density of the traffic can be, for example, collected from a third-party server including information relating to the traffic in a region including one of the positions POS₁, POS₃.

When the first user U₁ validates/accepts the query REQ₃, a message is sent to the server SERV such that a piece of information is generated to the device EQ₂ of the user U₂. The information diffused to the device EQ₂ thus includes data relating to the meeting point POS3. This step of generating a piece of information generated by the server is referenced MEET INFO in FIG. 1.

The server SERV is thus able to automatically modify the database to pass the status of the vehicle AUTO₁ from “available for reservation” to “unavailable for reservation”. This step is referenced MODIF STATU in FIG. 1. The modification of the status of the vehicle can also occur during the sending of the query REQ₃ such that the vehicle no longer appears in other lists, concurrent and generated to users in neighboring zones.

According to an embodiment, the user U₁ can select additional predefined data in order to inform the user U₂ about them. As an example, a description of a space occupied by the vehicle AUTO₁ from among which: “double parking”; “red light”; “boat”; “delivery”; “moves”, etc. can be sent to the server SERV. It makes it possible to inform the user U₂ of a parking element making it possible to better recognize the vehicle AUTO₁ when the user U₂ will be approached by it. This embodiment is preferably implemented when the meeting position POS₃ is the position POS₁ and that it is therefore defined by the first user U₁.

According to another embodiment which can be complementary to the preceding embodiment, a parking description of the vehicle AUTO₁ can be sent to the server SERV for the user U₂. This information can be determined from among the following information describing an element of the vehicle: “indicating”; “warning”; “traffic lights”, etc. This information can be defined by the user U₁. To this end, an input interface of the device EQ₁ spontaneously sends a list including different types of parking such that the user U₁ only has to validate a proposition by selecting it.

According to another embodiment which can be complementary to the preceding embodiments, a complementary parking description of the vehicle AUTO₁ can be sent to the server for the user U₂. This information can be determined from among the following information describing an element of the vehicle: “a vehicle color”; “a vehicle model”, or also “a vehicle make”. Equally, upon inputting a parking description, an interface for inputting the device EQ₁ spontaneously sends a list including different complementary parking descriptions such that the user U₁ can specify an element aiming to facilitate the recognition of the vehicle by the second user U₂. In this embodiment, the first user U₁ validates a proposition by selecting it.

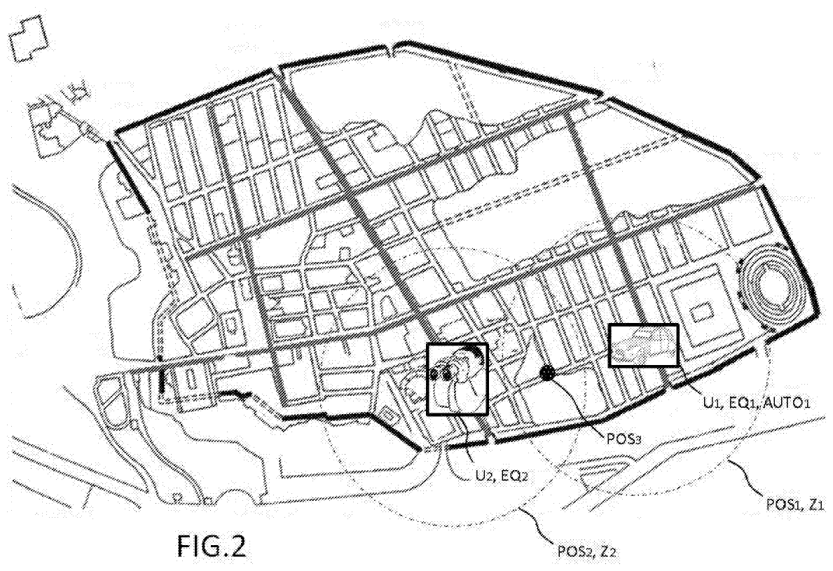

FIG. 2 represents a map of a city, in particular Italian, on which a vehicle AUTO₁ is represented, wherein is located the first user U₁ having a device EQ₁. Furthermore, a user U₂ having a device EQ₂ is represented in another place on the map. According to an embodiment, the devices EQ₁ and EQ₂ include a graphic interface generated by a piece of software and representing a geographical zone considering the paths of traffic such that each user U₁, U₂ can assess, for example, the distance and the path to join a meeting meet POS₃. Such a representation makes it possible to assist the users U₁, U₂ in order to indicate to them, the path to follow to get to the position POS₃.

After authentication of a user to an authentication server, the representation from the generation of a map makes it possible, furthermore, to view the vehicles available or the users likely to be interested in a vehicle.

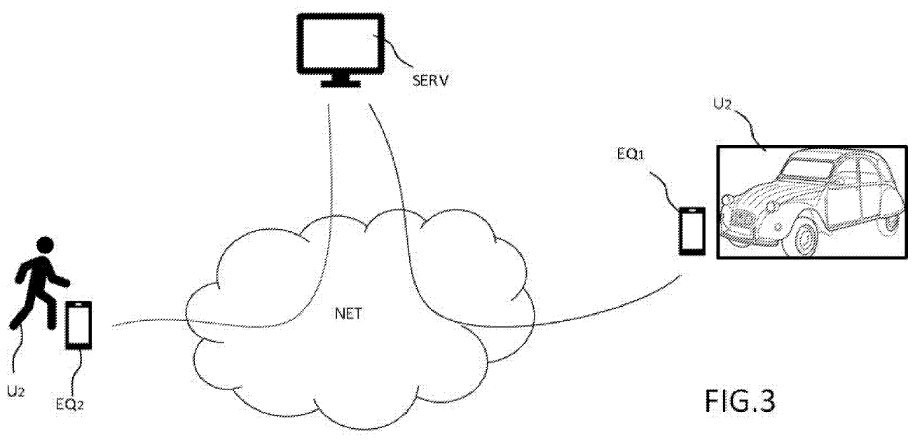

FIG. 3 represents a data network NET, for example internet, based on an infrastructure making it possible to route wireless communications coming from mobile terminals EQ₁ and EQ₂. The server SERV is, in this example, accessible from the network NET. A user U₂ having a device EQ₂ wants, in this example, to reserve a vehicle AUTO₁ of a user U₁ having a device EQ₁.

The invention also concerns to a computer program product including instructions for the implementation of the methods of the invention. Advantageously, the computer program can be installed on a smartphone or a digital tablet having a wireless communication interface.

The invention concerns such a mobile terminal including an interface, for example, touchscreen. The interface includes a screen for displaying input fields making it possible to define parameters relating to the description of the vehicle and for displaying, for example, an interactive digital map.

According to an embodiment, the mobile device includes a component making it possible to obtain a piece of geolocation information which can be collected by the software. Thus, a first query REQ₁ sent can comprise data inputted or defined by the user U₁ and data coming from another component or another piece of software such as the position POS₁ or the zone Z₁.

According to an embodiment, one single program makes it possible to execute the method for reserving a vehicle or the method for making available a vehicle.

According to an embodiment, the users are registered beforehand from the software and are known due to an ID being registered in a remote database. According to an embodiment, a database associates a vehicle AUTO₁ to a user U₁ when the latter uses a vehicle AUTO₁. This association makes it possible to define a use by default of the program when the latter is used.

Upon launching the program of the device EQ₁, the user U₁ is asked to make available the vehicle that they use or vehicle to be sought, for example, a car park in the proximity According to this same example, the user U₂ of which the ID is not associated with a vehicle, is asked upon launching the program to reserve a vehicle. Thus, the terminal of a user spontaneously proposes a piece of contextualized information according to if the ID of said user is associated (or not) to that of a vehicle in a remote database.

The invention also concerns a non-transitory recording support including the data, which once installed, in a computer or a mobile terminal type device, make it possible to execute the methods of the invention.

The arrangement of the different elements and/or means and/or steps of the invention, in the embodiments described above, must not be understood as requiring such an arrangement in all the implementations. In any case, it will be understood that various modifications can be applied to these elements and/or means and/or steps, without moving away from the sense and the scope of the invention.

1-15. (canceled)

16. A method for making available a vehicle, comprising:
generating a first query from a first device of a first user of a vehicle to a server from a data network in order to indicate a making available of said vehicle in a first zone;
receiving a third query by the first device from the remote server indicating a request for accessing said vehicle by a second user wanting to reserve said vehicle;
acceptance of the request for access from the first device,
wherein the first query comprises:
a piece of information on vehicle availability,
a piece of status information indicating a status of the vehicle specifying that the vehicle is in operation, and;
a first piece of geographical information.

17. The method according to claim 16, wherein the server sends a geographical position corresponding to a meeting point with the second user, wherein the geographical position:
is calculated from a first position corresponding to the current position of the vehicle; and/or is calculated from a second position corresponding to the current position of the second user; and/or
is determined from a common zone of the first zone defined around the first position and of a second zone defined around the second position.

18. The method according to claim 17, wherein the geographical position corresponding to the meeting point is calculated between the first position and the second position, by considering at least one of the following factors:
a moving direction of the vehicle,
a nature of a path wherein the vehicle is engaged, and
a better route in terms of distance, of time of arrival or of traffic to arrive until a position of a path leading to the second position.

19. The method according to claim 16, wherein the first piece of geographical information includes:
the first position corresponding to a current position of the vehicle and/or;
the first zone defined around the first position.

20. The method according to claim 16, wherein the third query includes a second piece of geographical information, said second piece of geographical information including:
a second position corresponding to a current position of a user and/or;
a second zone defined around the second position.

21. The method according to claim 16, wherein the third query includes a piece of distance or time information further including an estimated duration calculated from a current position of the vehicle and a third geographical position.

22. The method according to claim 16, wherein the status information further includes a piece of data corresponding to:
a description of a space occupied by the vehicle from at least one of double parking; red light; boat; delivery; and moves, and/or;
a parking description of the vehicle from among which indicating; warning; and traffic lights, and/or;
a description of the vehicle from among at least one of color, model, make, and year.

23. The method for making available a vehicle according to claim 16, further comprising:
recording in a memory of the server of the availability information of the new vehicle and of the first piece of geographical information following the receiving, to the first query.

24. The method for making available a vehicle according to claim 16, further comprising:
receiving a second query by the server coming from a second device of a user, said second query including a request for reserving a vehicle available in a second zone;
generating a list of vehicles including data relating to their availability to the device of the pedestrian, said list including the first vehicle;
sending said list of vehicles to the second device;
selecting the first vehicle from the second device; and
sending the third query to the first device.

25. The method for making available a vehicle according to claim 24, wherein the acceptance of the request for access from the first device comprises:
generation of a message by the first device to the server validating the making available of the vehicle; and
generation of a message by the server to the second device mentioning a meeting position.

26. A computer program product including a calculator and a memory for the implementation of any one of the steps of the method of claim 16.

27. A method for reserving a vehicle ready for use comprising:
generating a query from a device of a user wanting to reserve a vehicle ready for use, said query being sent to a server from a data network in order to indicate a request for accessing a vehicle in a zone defined around a given geographical position;
receiving a message including a list coming from the server, said list including a set of data relating to available vehicles, and of which at least one vehicle is associated with a piece of status data of the vehicle specifying that the vehicle is in operation;
selecting said vehicle and sending a reservation command from the vehicle to the server;
receiving a message by the device of the user coming from the server indicating a position of said vehicle and a descriptive element of the vehicle; and
an acceptance of the reservation by means of the device of the user.

28. The method according to claim 27, further comprising:
sending, from the server, of a geographical position corresponding to a meeting point of the user, wherein the geographical position:
is calculated from a first position corresponding to the current position of the vehicle; and/or
is calculated from a second position corresponding to the current position of the user; and/or
is determined from a common zone of the first zone defined around the first position and of a second zone defined around the second position.

29. The method according to claim 17, wherein the first piece of geographical information includes:
the first position corresponding to the current position of the vehicle and/or;
the first zone defined around the first position.

30. The method according to claim 18, wherein the first piece of geographical information includes:
the first position corresponding to the current position of the vehicle and/or;
the first zone defined around the first position.
